(19) United States
(12) Patent Application Publication
(10) Pub. No.: US 2024/0100476 A1
(43) Pub. Date: Mar. 28, 2024

(54) ELECTROCHEMICAL CELL AND METHOD OF PROCESSING A GASEOUS STREAM CONTAINING OXYGEN

(71) Applicant: ENAPTER S. R. L., Crespina Lorenzana (IT)

(72) Inventors: Jan-Justus SCHMIDT, Pisa (IT); Antonio FILPI, Pisa (IT); Sean Crawford CHAPMAN, Pisa (IT); Lazarus DIAMOND, Pisa (IT); Daniele PROCACCIO, Pisa (IT); Alessandro CAPPELLETTI, Pisa (IT)

(21) Appl. No.: 18/257,097

(22) PCT Filed: Dec. 13, 2021
(86) PCT No.: PCT/EP2021/085541

§ 371 Date: Jun. 12, 2023

(30) Foreign Application Priority Data
Dec. 14, 2020 (GB) 2019699.4

(51) Int. Cl. B01D 53/32; C25B 1/02; C25B 5/00; C25B 9/23; C25B 9/77; C25B 11/032; C25B 13/02; C25B 15/029; C25B 15/08; G01N 27/407

(52) U.S. Cl. CPC B01D 53/326; C25B 1/02; C25B 5/00; C25B 9/23; C25B 9/77; C25B 11/032; C25B 13/02; C25B 15/029; C25B 15/083; G01N 27/4072; G01N 27/4073; B01D 2256/12; B01D 2257/108; B01D 2257/80

(57) ABSTRACT

An electrochemical cell, or stack thereof, wherein each cell of the stack comprises at least: a membrane electrode assembly (MEA), the MEA comprising at least: a cathode, an anode, and an anion exchange membrane therebetween, an inlet to the cathodic half-cell for the introduction of oxygen at a first pressure, and an outlet from the anodic half-cell for the transfer of oxygen at a second pressure, and means to provide a required power to the cell. In one embodiment, the purification and compression of oxygen occurs by utilisation of the following reaction pathway: AEM Cathode O₂+4e⁻+2H₂O→4OH⁻; AEM Anode 4OH⁻→O₂+4e⁻+2H₂O.

The present invention relates to an electrochemical cell and a method of processing a gaseous stream containing oxygen, optionally by utilizing one or more electrochemical cells arranged in a stack. The cell or stack may, for example, be used for the purification and compression of oxygen, for the detection of oxygen in a stream, and power generation.

Oxygen has a plurality of uses ranging from medical applications to refining metals and manufacturing processes such as glass, pharmaceuticals and more. Like other gases, it is required to store such gases under pressure, else the volume would be simply too high.

Electrolysers are devices used for the generation of hydrogen and oxygen by splitting water. Such systems generally fall in one of three main technologies currently available, namely anion exchange membrane (AEM), proton exchange membrane (PEM), and liquid alkaline systems. Other systems, such as solid oxide electrolysis, are available. At present the focus tends to be on hydrogen as an energy vector, but the generated oxygen need not be overlooked.

Hydrogen and oxygen may be produced electrolytically in an environmentally friendly way, as disclosed in WO 2011/004343. It is preferable to generate “green” hydrogen, removing the reliance upon fossil fuels.

Conventional methods for compressing gases include mechanical and non-mechanical means. There are a plurality of issues such as the required energy for mechanical compression, contamination of the oxygen by oils/lubricants in the compressor, and the pre-drying required. Mechanical compressors also require regular maintenance due to the presence of moving parts, and are inherently loud rendering them undesirable in many locations. Additional considerations include the power supply for such compressors, and their cost.

The object of the present invention is to provide means, and a method, for electrochemically compressing, and purifying, oxygen.

According to the invention there is provided an electrochemical cell comprising:
a cathodic half-cell having an inlet configured to receive a gaseous stream comprising oxygen at a first pressure;
an anodic half-cell having an outlet configured to transfer oxygen at a second pressure;
a membrane electrode assembly (MEA) separating said anodic half-cell and said cathodic half-cell; and
a power source;
wherein said MEA comprises at least:
a cathodic electrode
an anodic electrode; and
at least one anion exchange membrane (AEM) therebetween.

As used herein, the term “cell” is used to refer to an electrochemical cell. A stack is normally considered a plurality of cells, however, the term may be used to describe a single cell within a stack, or the whole stack.

As used herein, reference to the at least one AEM is intended to include variants wherein the MEA comprises a composite AEM, an AEM either side of a microporous layer (MPL), an AEM either side of a water management membrane, or other such structures. A water management membrane (WAMM) may be on one or both of the anodic and or cathodic side, or between two membranes, AEM or otherwise, the same applies to the MPL.

As used herein, the terms moist, hydrated and humidified, with respect to the anion exchange membrane, are to be used interchangeably.

As used herein, moisture and humidity sensor are used interchangeably, and is intended to cover any and all sensors capable of detecting the presence of water.

As used herein, the term anode and cathode may be used interchangeable with anodic half-cell and cathodic half-cell. The terms anodic and cathodic electrode, however, refer to the portions of the MEA where the oxygen reduction reaction (ORR) and oxygen evolution reaction (OER) occur. The anodic and cathodic electrodes typically comprise catalysts for carrying out the reactions. The anodic and cathodic electrodes can be seen as catalyst layers in the AEM.

As used herein, the term anion exchange membrane (AEM) may be used for any ion-exchange materials that has anionic exchange properties with or without having also cationic exchange properties (e.g. cations may be added to the AEM in the form of potassium ions added by KOH doping of PBI-based materials, or by using mixed cationic and anionic polymers and/or functionalities). The additional cationic groups may or may not participate in either, or both, half reactions.

As used herein, the term compression generally refers to the increase of pressure, however in some embodiments it is envisaged that a decrease of pressure may be desired, and the term compression may be used synonymously with decompression. The electrochemical cell may be referred to as a compressor, but this does not exclude variants wherein the cell operates as a sensor or means for purification only, or alternatively an electrolyser.

As used herein, the term destination refers to any end use for purified and or compressed oxygen, such as but not limited to refuelling, or storage.

The balance of plant (BOP) including means for temperature and pressure regulation, valves, wiring etc. are not shown. The connections of the power supply to the electrochemical cell or cells is also not described herein.

As oxygen is often required at elevated pressures, higher than those achievable by a single cell compressor, it is envisaged that one or more cells may be used in series, the plurality of cells constituting a stack. It is noted that one or more stacks may be used in a compressor. Additionally, if the concentration of impurities is above a certain level, more than one cell may be desired to ensure removal of all impurities from the oxygen stream.

According to the invention there is provided a second embodiment of an electrochemical cell assembly comprising at least first and second electrochemical cells substantially as described above, configured in a stack, wherein the outlet of the anodic half-cell of said first electrochemical cell is in fluid communication with the inlet of the cathodic half-cell of the second electrochemical cell.

As used herein, the term stage of cells refers to one or more cells wherein the oxygen entering the cathode of each cell or cells in a stage is substantially similar in pressure to each other, and the anodic outlet of each cell or cells in a stage are combined to become the feed to the cathode of the cell or cells in the next stage. Each stage may have connection in parallel, series, or a combination thereof. It will be appreciated that references to connection or arrangement in parallel or series are, unless otherwise stated, intended to refer to the flow of oxygen through the cells (rather than e.g. the electrical connections between cells).

It is common practice to have multiple stages of compression when compressing a fluid. The same can be applied to electrochemical compression. In one embodiment of the present invention, it is envisaged that there are multiple stages of compression achieved by having one or more cells at each stage, as discussed above. Oxygen enters the cathodes of the cell or cells in the first stage at a first pressure, with the anodic outlet or outlets from the cells in the first stage being at a second pressure, said outlets being combined. The anodic outlet from the first stage at the second pressure is normally the input of one or more cathodic half-cells at the second stage, or if there is only one stage of compression/purification the outlet goes to storage. Such a structure allows for a higher volume of oxygen to be compressed by a single stack with cells of the same size.

It is envisaged the cells or stacks of each stage can be arranged in parallel, or as a means to save space, in series with the pipework and BOP allowing for the multiple stages. The various arrangements are depicted in the figures. Means for separating and or insulating each cell may be provided.

The sum of current applied to the cell, or stack thereof, for each group of cells, or stage of compression, is generally substantially the same as the next group or stage of compression. Variances in the required current across the membranes at each stage occur if the pressure differential in each cell at one stage differs to the other. A higher-pressure differential requires a higher current density in order overcome oxygen back-diffusion (cross-over). This may, however, result in lower faradic efficiency. This embodiment is depicted in the figures.

As well as for compression, the cells described herein may also be used to purify an oxygen stream. Normally, the purification occurs with simultaneous compression. In such an embodiment the second pressure is higher than the first pressure. It is, however, also possible for the cells to be run with no pressure difference to operate as a means for purification only. Any known means for regulating pressure may be used on the or each anodic outlet such that the oxygen leaves the anodic outlet at an elevated pressure. In alternative embodiments, there may be a requirement to decompress oxygen, and the means for regulating pressure may be made accordingly.

In an AEM compressor with a single cell, or stack thereof, the oxygen enters the cathodic half-cell of the first cell at a first pressure (P1), and oxygen is pressurised to a second pressure (P2) in the first anodic half-cell. The oxygen stream at the second pressure (P2) is communicated from the first anodic half-cell to the cathodic half-cell of the second cell. The oxygen is pressurised to a third pressure (P3) in the second anodic half-cell, and so on. In a series of cells, the pressure gets progressively higher with each cell, for example, P1<P2<P3<P4 etc. It is envisaged that the anodic half-cell has a higher pressure than the cathode, and the oxygen contained therein is purer than the oxygen in the corresponding anode and the oxygen of previous cells.

AEM systems are inherently different to PEM as it is hydroxyl anions, OH⁻, which cross the membrane and not hydronium (solvated proton). As such, the mechanism of operation is different, and novel issues must be overcome. The reactions are as follows:

AEM Cathode (Oxygen reduction reaction (ORR))

O₂+4e⁻+2H₂O [symbol] 4OH⁻

AEM Anode (Oxygen evolution reaction (OER))

4OH [symbol] O₂+4e⁻+2H₂O

Electrochemical compression of oxygen in an AEM based system may require further drying as water is generated at the anode in parallel with oxygen compression. This aids in ensuring the membrane is sufficiently moist, a benefit of operating in the presently described format.

One means for minimising the load on downstream dryers prior to storage is having an MEA that is preferably adapted to retain water rendering it available for reaction in the cathodic half-cell. Other means for water management are described below.

In PEM systems platinum or platinum group metals (PGM i.e. ruthenium, rhodium, palladium, osmium, iridium, and platinum) are required as a catalyst at both the anode and the cathode. For instance, IrOx may be used for the OER and/or Pt may be used for the ORR. In the present invention of AEM electrochemical compression, PGM catalysts, such as those mentioned above, may be used, but are not required rendering the system inherently more sustainable. Any known catalyst for the OER and/or ORR may be used, the present invention is not intended to be limited by the catalyst. Example of non-PGM catalysts that may be used include, but are not limited to, catalysts containing: Ni, Cu, Co, Fe and alloys thereof. The anodic catalyst and cathodic catalyst may be the same, or different.

The MEA may be ionomer-free, and/or binder-free. Alternatively, it may have both, or either of, ionomer and binder. It is envisaged, in one embodiment, that the MEA comprises a substrate with electrically conductive whiskers and a thin catalyst layer is sputtered thereupon to maximise surface area and minimise catalyst requirement. The intimate contact with a high surface area mitigates the requirement for ionomer.

The anion exchange membrane (AEM) may be any membrane with the desired properties. The properties required are mainly high ionic conductivity, low gas permeability, high mechanical strength and hydrophilicity. However, it is envisaged that the membrane may be a composite membrane. The composite membrane may comprise an inorganic filler, e.g. of hygroscopic particles, such as nano-particles of clay such as, but not limited to, montmorillonite, or an organic filler such as any ionomer nanoparticles or fibres produced, but not limited to, by electrospinning or a combination of thereof. The ionomer may be an anionic ionomer.

Ionomers are charged polymers which are inherently hygroscopic. Composites can be a mixture of two or more ionomers with differing backbones such as, but not necessarily limited to, styrene-ethylene-butylene-styrene (SEBS) and polybenzimidazole (PBI). At least one, and preferably both, of the SEBS and PBI polymer backbones are typically functionalised to provide the ionomer(s) with a charge.

Another example of a composite membrane is where a single polymer, preferably an ionomer such as SEBS or PBI, is present and a filler, organic or inorganic, is mixed with it. Though less preferred, multiple ionomers (such as SEBS and PBI) may be mixed with a filler. Suitable fillers are described above and include montmorillonite and organic polymers such as uncharged, but preferably hydrophilic, organic polymers such as poly-ethylene glycol or cellulose. Other organic fillers that could be used are plasticisers. Plasticisers may be used to impart improved mechanical properties without adversely effecting other properties, e.g. conductivity, crossover, etc.

Thus, compositive membranes may contain organic and/or inorganic components, charged and/or uncharged components, and be hydrophilic and/or hydrophobic. Furthermore, although PBI and SEBS have been mentioned as a possible polymers, it will be appreciated that other polymers may alternatively be used.

It is envisaged that the membrane will have a polymeric backbone with an inorganic and/or organic filler, such as those described above, that filler being hydrophilic. The hydrophilic properties retain the water and help ensure the oxygen at the raised pressure remains dry. It is envisaged that the polymer may be PBI, preferably modified to increase its alkaline resistance and/or by covalently binding a positive charge, but this is not intended to be a limiting feature. Additionally, it is envisaged that the membrane may be doped with excess OH⁻. This may be achieved by doping the membrane with a, preferably highly concentrated, alkaline solution (e.g. KOH). The excess OH⁻ will neutralize acidic hydrogen (e.g. pyrrolic hydrogen in PBI), imparting ionic conductivity. This is in contrast to a traditional AEM with an ion-exchange capacity intrinsically derived from covalently bound positive charges (e.g. bonded quaternary ammonium salt). The source of OH⁻ may be in any form but is preferably aqueous.

When electrochemically compressing oxygen, the pressure differential across the membrane must be considered. If too high, the membrane or other components may be damaged. Increasing the mechanical strength of the membrane may reduce its performance in other areas such as ionic conductivity. There is no theoretical limit to the pressure differential in a single cell, however practically there are limitations due to the integrity of the components, and crossover. It is envisaged that each cell will be able to see a pressure increase between 1 bar and 2000 bar, more preferably between 1 bar and 1000 bar. The pressure increase in each cell may be in the range of 10 bar to 500 bar, 10 bar to 100 bar, 10 bar to 80 bar, 20 bar to 50 bar, 30 bar to 40 bar. It is envisaged that the total pressure increase in the AEM electrochemical compressor will be between 200 and 1500 bar, more preferably between 350 and 1000 bar. Yet even more preferably, the total pressure increase will be between 700 and 900 bar.

A stack in an electrochemical cell assembly may contain at least 10, preferably at least 15, and more preferably at least 20 cells. A stack in an electrochemical cell assembly may contain up to 100, preferably up to 50, and more preferably up to 40 cells. Thus, a stack in an electrochemical cell assembly may contain from 10 to 100, preferably from 15 to 50, and more preferably from 20 to 40 cells. These cells are preferably connected in series.

Whilst it is envisaged that the electrochemical compressor would work with oxygen generated by any known means it is preferred to utilise a green oxygen source. To achieve this, it is preferred that the inlet stream is an outlet stream from an electrolyser, more preferably still, an AEM electrolyser. Contaminants may be present, but should be limited to water and trace amounts of hydrogen. Other contaminants, if present, should not run the risk of poisoning the catalyst, this excludes species such as carbon monoxide. Other contaminants may react with the OH⁻ e.g. acids or salts containing anions different to OH⁻.

The present invention both pressurises and purifies the oxygen, any present contaminants should not pass beyond the first half-cell. The water should remain membrane bound, or be managed by the water management means disclosed herein, and the OH⁻ generated at the cathode migrates to the anode whereupon it is consumed by the anodic reaction. Some water may be transported from the cathode to the anode with the OH⁻ via electro-osmotic drag. The water flux across the membrane, in both magnitude and direction, is dependent upon the current supplied.

It is envisaged that the power may be supplied as DC, AC, pulsed current or reverse pulse current. However, in the preferred embodiment the power supply is any one of DC, pulse current, or reverse pulse. The benefit of reverse pulse being that the electrodes will be purged of poisons when current is reversed temporarily.

The membrane in each and every cell must remain sufficiently moist. The water generated in the anodic reaction serves this purpose, along with the membrane being selected for its general properties. The water produced should be sufficient to maintain the moisture of the membrane, without flooding the cathode or being stripped in the oxygen anodic flow. In order to inhibit/prevent undesired movement of water, means for water management are used and disclosed herein. Alternatively, additional water may be introduced, said water preferably in a vapour phase, although introduction of liquid water may work.

For example, a microporous layer (MPL) may be employed which is porous enough to permit the movement of oxygen, but prevents the flux of liquid water across the MPL in either direction. Furthermore, the membrane may have a hydrophilic component, in order to fine tune the water content in the respective catalyst layer, while maintaining sufficient membrane bound water.

Whilst the MEA may consist of an anode, anion exchange membrane and a cathode, normally there will be more layers. A gas diffusion layer (GDL) may be present on one of, or both of the cathode and anode. If present the MEA is structured: anode GDL, anode catalyst layer, membrane, cathode catalyst layer, cathode GDL. In another embodiment, an MPL may be used. The MPL is preferably but not limited to being on the cathode or anode side only, but may be used on both sides and the MPL being selected for its porosity and hydrophobic properties. A water management membrane may also be used on the cathodic and/or anodic side, discussed further below. Alternatively, an MPL or water management membrane may be situated between two AEMs.

It is envisaged that the MPL may be in contact, or within, the membrane of each cell on the cathode or anode side or only one or some of the membranes. It is further envisaged that the MPL, if used, may have different properties at various locations in the stack, such as being more hydrophobic in the latter cells. An MPL which is more hydrophobic in the final cell, or cells, would prevent (excess) water from being present in the final outlet, which may be less desirable in the first cells should other properties of the membrane be impacted by the varied MPL properties. MPLs are generally produced by casting a slurry containing an electronically conductive material and a binding agent upon a substrate. The electronically conductive material may be something, such as but not limited to, carbon black, nickel nano particles etc. The binding agent may be a hydrophobic polymer, such as but not limited to PTFE, FEP etc. The pore size, distribution, distribution of pores of various sizes, hydrophobicity and other physio-chemical properties can be adjusted by varying each constituent component, their ratios and or the manufacturing procedure. In any case a dryer may still be employed to dry the oxygen stream from the final cell, or cells, prior to storage.

Another means for water management is the inclusion of an ionomer in the MEA on one or both sides of the AEM. It is preferred that there will be ionomer on both the cathodic and anodic sides of the membrane. It is envisaged, for the purpose of water management, there will be relatively more ionomer on the cathodic side than the anodic cathodic side. Alternatively, it is envisaged that there may be no ionomer on the anodic side of the AEM, whilst there is ionomer on the other side of the membrane. Indeed, there may be substantially the same amount of ionomer on both sides of the MEA. It is envisaged that the ionomer may be bypassed by having an ultrathin catalyst layer achieved by having a catalyst coated membrane (CCM) or decal method/decal transfer. Preferably, the ionomer is present on any one or both of the anodic and cathodic sides of the MEA.

Yet another means for water management in the membrane is the inclusion of a water management membrane in the MEA. Such a membrane will preferably be hygroscopic, and on the cathodic side of the MEA. The water management membrane will also preferably be highly ionically and/or electronically conductive, depending upon its location in the MEA. The water management membrane may be on the anodic side, cathodic side or both. In yet another embodiment, the water management membrane may be sandwiched between two AEMs, the water management membrane in any of the embodiments being part of the MEA. If between two AEMS, then high ionic conductivity in the water management membrane is desirable. If in contact with either catalyst layer, then it is preferred for the water management membrane to have high electric conductivity. An example water management membrane would be an ionomer mixed with carbon black.

Still yet another means for water management is the utilisation of a composite anion exchange membrane, for instance as described previously, wherein the filler/nano/micro particles have hygroscopic properties. It is envisaged that such particles may have a concentration gradient within the membrane. The cathodic side of the membrane may have a relatively higher concentration of said particles compared to the anodic side, or more preferably the inverse. Alternatively, the highest concentration may be in the middle of the composite AEM with less towards the cathodic and anodic sides, or the cathodic and anodic sides may have a relatively higher concentration than between the two sides. In yet another alternative, a water management membrane may be situated between two AEMs wherein the concentration of the filler/nano/micro particles having hygroscopic properties may vary as above. In one embodiment the hygroscopic particles in the AEM vary in a non-linear concentration.

It is envisaged that any one of the water management mechanisms mentioned in this document can be used alone, and or in combination with each other.

According to the invention there is provided a method of processing a gaseous stream containing oxygen, comprising providing an electrochemical cell substantially as described above, feeding a oxygen-containing gaseous stream to the inlet of the cathodic half-cell, and transmitting oxygen from the outlet of the anodic half-cell.

All structural limitations discussed pertaining to the apparatus apply to the method of operating the cell, accordingly the same is said for the method of using the compressor with a stack of cells.

The method of operating a single cell compressor can largely be applied to operating a compressor comprising a stack of cells.

According to the present invention there is provided a method of processing a gaseous stream containing oxygen, comprising providing an electrochemical cell assembly substantially as described above, feeding an oxygen-containing gaseous stream to the inlet of the cathodic half-cell of the first electrochemical cell in the stack, transferring oxygen from the outlet of the anodic half-cell of each electrochemical cell in the stack to the inlet of the cathodic half-cell of another electrochemical cell, and delivering oxygen from the output of the anodic half-cell of a last electrochemical cell in the stack to an external destination.

For the electrochemical cell, the electrochemical cell assembly and the methods described above, the inlet stream may be directly from an electrolyser, oxygen storage tank or any other conceivable source of oxygen at reasonable levels of purity.

The only contaminants considered likely, especially from the electrolytic production of oxygen, are water and hydrogen. However, it is possible that other contaminants may be present these may reduce the efficiency of the first few cells, as such means for purging the cathodic half-cells may be provided. In one embodiment, ambient oxygen from the atmosphere can be selectively purified and compressed. In any use case, a filter for particulates may be included. In such embodiments where atmospheric oxygen is to be purified, it is preferred to remove CO₂, thereby avoiding carbonation issues. Means for the removal of such contaminants include but are not limited to utilising an amine trap, said amine trap being regenerated by thermal cycling, or by using another electrochemical cell. Preferably, the cathodic catalyst is not active towards OER, and the hydrogen or other contaminants present are vented from the cathodic half-cell.

All structural limitations discussed pertaining to the apparatus apply to the method of operating the cell or stacks and shall be handled accordingly.

It is envisaged that the final outlet of the stack is connected to a storage tank, or tanks, adapted to house oxygen at the desired pressure, this can be anywhere from 30 bar to 1000 bar. The pressure can be raised to any required level, including industry standards of 300 bar, 700 bar and 1000 bar. It is envisaged that the pressurised oxygen from the outlet could be directed to any system or means which uses pressurised oxygen, or for storage.

As water is generated in the or each anodic compartment, the oxygen is effectively moistened whilst compressed. In order to maintain the required conductive properties of the membrane, it is important to ensure the, or each, membrane within the stack is adequately hydrated. If the water generated in anodic half-cell is insufficient, it is envisaged that stable water content of the membrane can be achieved by adding water to the oxygen inlet to ensure the feed is moist. However, it is possible too much water may be added to the stream or generated, causing the outlet stream to be moist, or the cathodic half-cell to be flooded, preventing oxygen from coming into contact with the cathodic catalyst. This would achieve the goal of pressurizing the oxygen but leaving it moist or would decrease the cell efficiency due to mass transport overvoltages. To achieve both pressurized and dry oxygen, a control system may be used, described below, alone or in combination with a dryer after the final cell.

In order to control the moisture in the system, it is envisaged at least two moisture sensors will be employed. A first moisture sensor being on the feed stream, and a second moisture sensor being on the, or each, outlet stream but most importantly the outlet of the oxygen at the final cell. It is also possible to include a moisture sensor on one or all of the cells in the stack to determine the saturation of a membrane at a given point in the stack, thereby enabling the operator to determine if a membrane is inoperably dry within the stack. Moist oxygen from the outlet may either be vented, or preferably decompressed and recirculated to the inlet, as discussed below, if a dryer is not sufficient or in place. Alternatively, a thermal conductivity sensor may be used instead of a moisture sensor. Any suitable alternative form of sensor may be used.

The two or more sensors are operably connected to a control module, such as but not limited to a PID controller. If moisture levels fall below a pre-determined threshold, water will be introduced to one or more water inlets. It is envisaged that a plurality of inlets for the introduction of water, in liquid but preferably vapour state, could be on the stack, normally into either a cathodic compartment, anodic compartment or between cells. However, due to the increasing pressure along the stack it is preferred that a single inlet for additional water is provided on the feed stream, at a first pressure, said inlet being after the first sensor, and said water inlet being before the stack, or into the first anodic compartment. One embodiment involves passing the gas to be processed through a humidifier, and a bypass may be provided should humidification not be required. If the feed is too humid, an optional condenser may be used.

If moist oxygen leaves the final cell of the compressor, it may be an issue for long term storage. Moist oxygen may not be fit for purpose, or may damage the storage tank and therefore should not be stored. Accordingly, in the event of moist oxygen leaving the stack, it is envisaged that the oxygen can be vented, or preferably dried. Optionally, the recovered water may be recirculated, or used in other water demanding processes. In a preferred embodiment, the moist oxygen can be recirculated from the outlet prior to the destination of the oxygen. It is envisaged that the recycled stream would be from the outlet to the inlet via means for decompressing the pressurised oxygen to a level suitable for reintroduction at an earlier stage of the compressor stack.

It is envisaged that an interim storage tank may be provided on the recycled stream to minimise the need for venting, should there have been an excess of moisture. It is envisaged that the interim storage tank could have means for draining condensed moisture to remove it from the tank. Ideally, means are provided to direct the water for reuse in this or another system.

Green oxygen produced via electrolysis normally happens by utilising excess energy from renewable source. This inevitably results in discontinuous generation of oxygen, the oxygen generally being considered a by-product of the process. Therefore, the feed stream for the electrochemical compression stack may also be discontinuous. The electrochemical purifier and compressor is adapted for intermittent operation. A buffer tank may be employed between the electrolyser and compressor for storage of oxygen at an intermediate pressure, e.g. 35 bar, to allow for a more consistent supply of oxygen to the AEM compressor.

Whilst the membranes may all have the same thickness, it is envisaged that the membrane (AEM and/or water management membrane, alone or together) thickness may vary between the cells of a stack. In one embodiment, the thickest membrane may be in the first cell, with subsequent cells having thinner membranes. Alternatively, the first cell may have a thinner membrane with the membranes becoming progressively thicker to aid water retention. The inverse with a thicker membrane at the beginning with them becoming progressively thinner to mitigate drying of the cathode. In yet another embodiment the thickness can vary non-linearly, going from relatively thin to thick and thin again, or thick to thin to thick again, or any variant thereof. Thicker membranes will retain more water, and so could ensure the membranes are more resilient to moisture level variations ensuring that conductive properties are maintained, and that reducing the likelihood of the oxygen outlet being moist. Thicker membranes may also be more resilient to larger pressure differentials, allowing for fewer cells to be required to enact the same step change in pressure difference.

Thicker membranes are relatively resilient to greater pressure differentials, and higher pressures generally. That said, it is envisaged that supports for the or each side of the membrane may be provided. The supports may be any suitable material, namely one which will not react in a detrimental manner to the system. Any suitable membrane support may be used, such as but not limited to nickel foam. The support may be a mesh or any other suitable structure to aid the membranes resilience to mechanical stresses. Additionally, the membrane support helps prevent creep of the membrane at elevated pressure differentials.

In the preferred embodiment, the cell, or stack thereof, are provided with means for thermal management. The heating and/or cooling can ensure the optimum temperature is reached in the cell or cells. It is envisaged that this is above room temperatures, but below 100° C. It is envisaged that the optimum temperature will be below 90° C., more preferably below 80° C. In the preferred embodiment the temperature is between 45° C. and 65° C., more preferably still between 50° C. and 60° C.

It is envisaged that means for thermal management for the cell or stack may be provided. Heating and or cooling may be provided by usage of a heating cartridge or a radiator installed on a or each endplate of the stack, or cell, and/or intermediate frames for example. Another alternative is liquid to be circulated inside or in contact with any of the above cited components, but preferably not in contact with any component which may impact the reaction or stack efficiency. Cooling of the outlet would allow for the condensation of water present, limiting the load, or removing the need for a drier. The condensed water can be collected for reuse, or as a coolant in the stack itself offering an all-in-one drying, water management and thermal management system.

Whilst it is envisaged that the stacks are constructed with each cell having a substantially identical cross-sectional area, the stack may comprise cells of varying cross-sectional areas. In such an embodiment, the cross-sectional area would become progressively smaller from the first to last cell, accordingly increasing the current density to maintain the same oxygen flow, proportional to the total current, aiding the pressure increase passively due to the reduced volume and improve water management by increasing electroosmotic drag in case of excess water is transported by one cell to the next by the anodic oxygen stream. Electro-osmotic drag will pull water to the side where water is produced (OER anode), so it could be helpful if an excess of water is transported to the cathode which is susceptible to flooding. On the contrary, if the cathode is subjected to dehydration, a lower current density and/or a thinner membrane will be needed to ameliorate the water balance across the MEA. An example solution for this is a thinner membrane being used to balance back diffusion of water and electro-osmotic drag. The opposite, i.e. the cross-sectional area would become progressively larger from the first to last cell, accordingly decreasing the current density, aiding water management in case of progressive dehydration from one cell to the next, although the water generated as a result of the reaction is expected to be sufficient. Each cell cross section may vary, or multiple cells in the stack may have the same cross-sectional area prior to area reduction. In yet another embodiment the cross section may vary non-linearly from relatively large to small and large again, or small to large to small.

The cross section of the cell or stack thereof may be any shape. It is envisaged that the shape will be either circular, square or rectangular. Alternatively any other shape may be used, such as, but not limited to a: pentagon, hexagon, heptagon, octagon and so on. Alternatively, any other regular, or irregular shape may be used for the cross-sectional area.

It is envisaged that a combination of varying cross-sectional area and thickness of the membrane could be employed, as well as other described variants, such as the MPL, or GDL. In an embodiment wherein the cross-sectional area decreases along the stack, the membrane thickness could increase along the stack. The inverse approach of decreasing cross sectional area and thinning of the membrane may also be used. Such a configuration would aid in increasing the pressure due to the reduced volume and would help maintain optimal water saturation throughout the or each MEA, insofar as the two opposing driving forces of water transport, electro-osmotic drag and back diffusion, will balance when the operating current density and membrane thickness are fine tuned. Other embodiments may use any combination of the afore mentioned variants.

It is important to ensure there is enough water on the or each membrane at start up, and assembly of the compressor should take this into account by ensuring the membranes, and MEA generally, are substantially saturated when assembled. It is also important that there is enough water on the or each membrane during standby conditions. Means for dosing with water may also be provided to the or each anodic cell.

Whilst the present invention is not intended to be limited by the anodic or cathodic catalyst or the method of depositing said catalyst, it is envisaged that the catalyst may be deployed by using a catalyst slurry or spray upon an electrically conductive substrate alternatively, the means of forming the catalyst layer include CCM or decal transfer method. The catalyst will normally comprise nanoparticles, and the electrically conductive substrate may be something such as carbon cloth on the anode and Nickel foam or felt on the anode and/or cathode. A binder will also optionally be used either a non-conductive example such as PTFE or an ionomer may also act as a binder.

It should be noted that the electrochemical compression requires no moving parts, with all the associated benefits thereof. Furthermore, the electrochemical compression has far lower energy requirements than alternative forms of compression, and is therefore inherently more environmentally sound and improves the overall efficiency when considering the production and management of oxygen. The compression may be achieved in a single stage, dependent upon the resilience of the membrane used. Additionally, the process can be isothermal as opposed to adiabatic.

The electrochemical compressor, as described herein, may be used in other applications with a substantially similar configuration.

It is envisaged that the oxygen to be compressed is obtained via electrolysis, or another green source, but may be from any conceivable source. In such instances, although applicable to all scenarios, the electrochemical cell or cells are likely to be operated intermittently. During ramp down/transition to standby procedures, the pressure gradient within the stack will equalise, as opposed to maintaining a pressure gradient. It is possible to obtain energy from the cell or cells by reversing the current flow to the stack during the transition to standby. The power generated may be stored by any known means for later use. Such operation minimises energy wastage. The energy coming from decompression of the pressurised oxygen, by exploiting the pressure differential which creates an electromotive force.

Whilst it is envisaged that the pressurised oxygen is leaving the cell or stack will be stored, an alternative embodiment allows for direct use in any system or application requiring pressurised oxygen.

Another alternative application for the electrochemical cell, or stack, as disclosed is as an oxygen sensor. The presence of oxygen gas within a stream may be detected by feeding the potentially oxygen comprising gas to the cathode of a cell and applying a voltage to the cell or stack. If oxygen is present, a current will be measured, the current being proportional to its partial pressure. Conversely a current may be applied and the measured voltage being indicative of the presence of oxygen in the gaseous stream. Additionally, an open circuit potential/voltage may be measured passively if there is a gradient in the oxygen partial pressure of each catalytic half-cell. In order to prevent a build-up of pressure in the cathode of a cell being used as an oxygen sensor, an outlet from the cathode to prevent undesirable pressure build up is required. Without said cathodic outlet, the stream being tested for oxygen would not have a route out of the cell. This is discussed further in another application below. If the cathodic flow rate is high, with a high % of oxygen in said stream, the electrochemical cell may be configured to act as a sensor only, or a simultaneous sensor and compressor. Pressure regulation means and a control system, as in other embodiments, would be required for either configuration.

Another means for detecting oxygen passively is to measure the cells open circuit voltage. In such an embodiment, the catalyst may be the same on both sides of the AEM. The open circuit potential is directly proportional to the partial pressure of the gas present. Calibration for such an embodiment of the sensor would be needed by introducing gaseous streams of known composition to the electrochemical cell.

Still yet another application for a single cell, or stack thereof, in accordance with the present invention is the separation, and compression, of oxygen from a stream containing not only oxygen gas. Some gases may negatively impact the longevity of the cell, or stack, such as but not limited to carbon monoxide, carbon dioxide, or ammonia. The contaminants should not cross the membrane, electrochemically or otherwise, and as such will remain in the cathodic half-cell. In order to prevent a pressure build-up in the cathodic half-cell of the first cell, an outlet is provided for the removal of the gas contaminants. However, some contaminants may cross due to diffusion. A purifying embodiment of the present invention therefore may employ multiple cells with a cathodic outlet. Alternatively, or as well as the additional cathodic outlets, relatively thicker membranes may be used in the first cell or cells of a stack to limit contaminant cross-over due to diffusion. It is possible some oxygen would remain in the cathodic outlet stream, and so it is envisaged that the gas may be recycled to the cathode for further purification. An oxygen sensor, for instance as described above, may be used to detect the presence of oxygen, and determine the need to recycle.

A cathodic outlet may be used on any cell in a stack for any embodiment but is most preferably implemented for use on the first cell, or stage of cells to allow for the purging of contaminants from the cathodic half-cell or cells. This does not preclude the inclusion of cathodic outlets on subsequent cells.

Means for regulating pressure may be provided on any one or more of the inlet to the anodic cell, the outlet of the anodic cell, if present, or the outlet of the cathodic cell. Such means includes but is not limited to a valve.

To help understanding of the invention, a specific embodiment thereof will now be described by way of example and with reference to the accompanying drawings, in which:

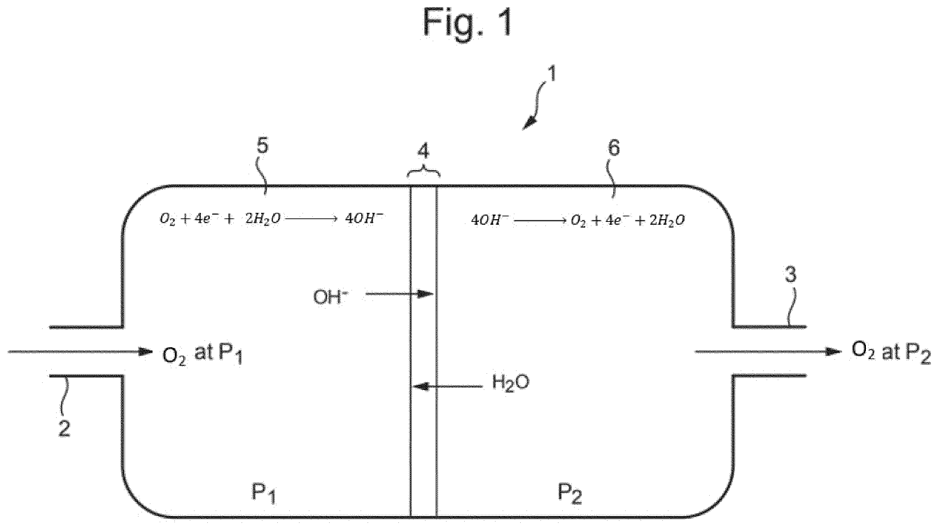

FIG. 1 depicts a single cell AEM electrochemical compressor,

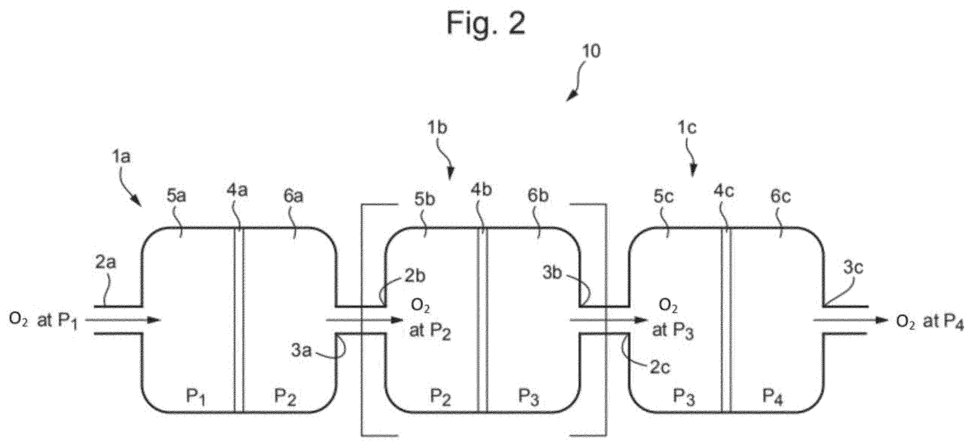

FIG. 2 depicts a plurality of cells forming an AEM electrochemical stack,

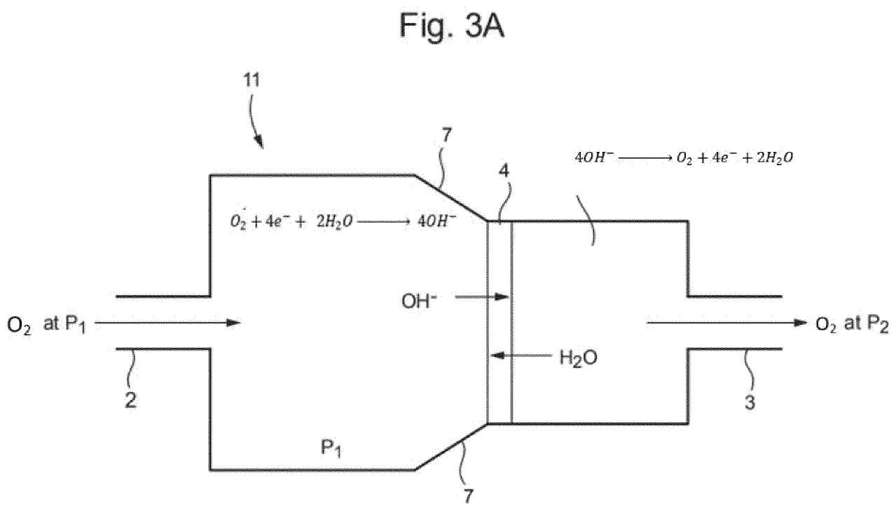

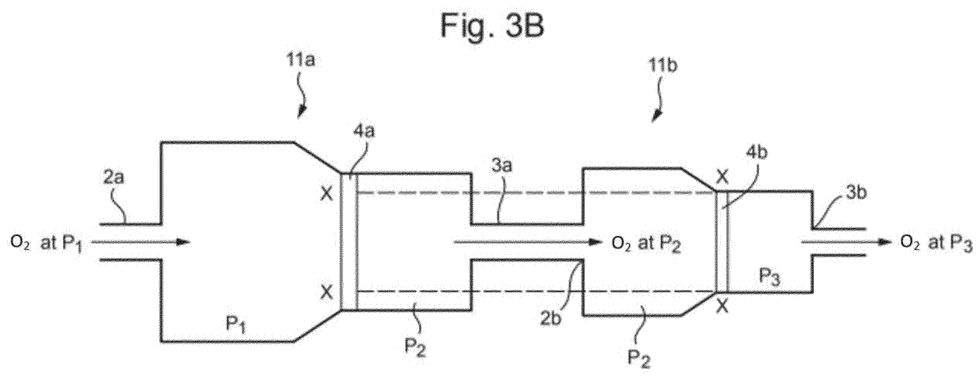

FIG. 3a depicts a single cell AEM electrochemical cell,

FIG. 3b depicts a plurality of cells forming an AEM electrochemical stack,

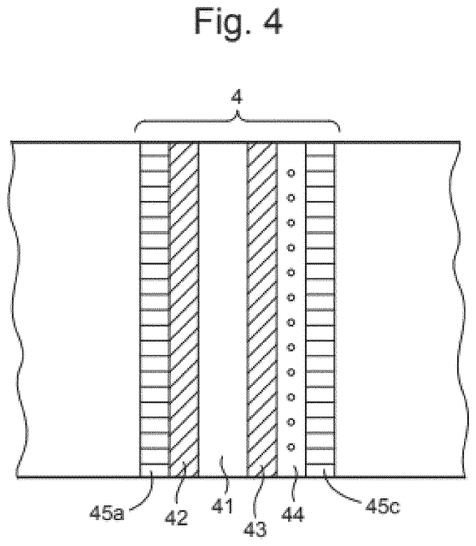

FIG. 4 depicts an MEA suitable for use in the present invention,

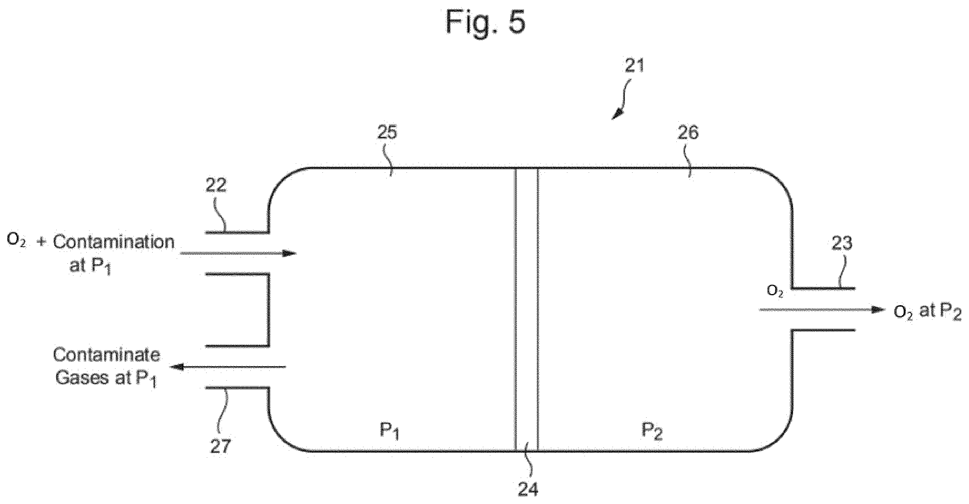

FIG. 5 depicts an electrochemical cell in accordance with the present invention suitable for use as either an oxygen sensor, or to strip oxygen from a stream of gas containing oxygen,

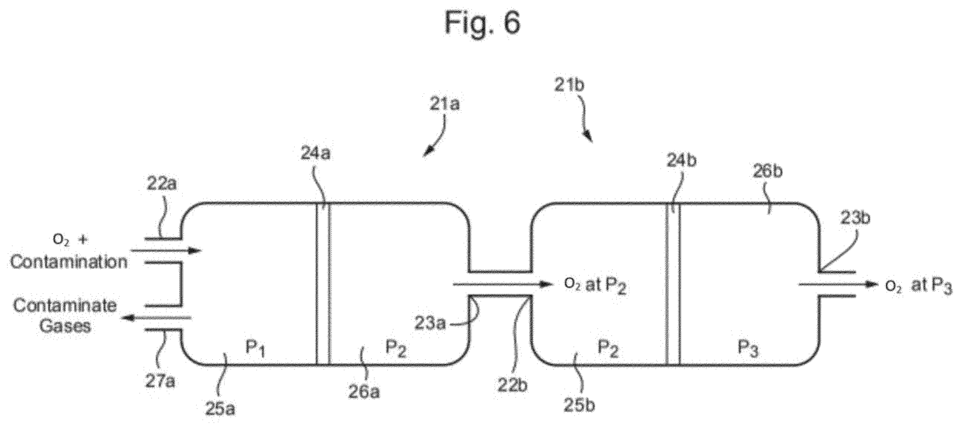

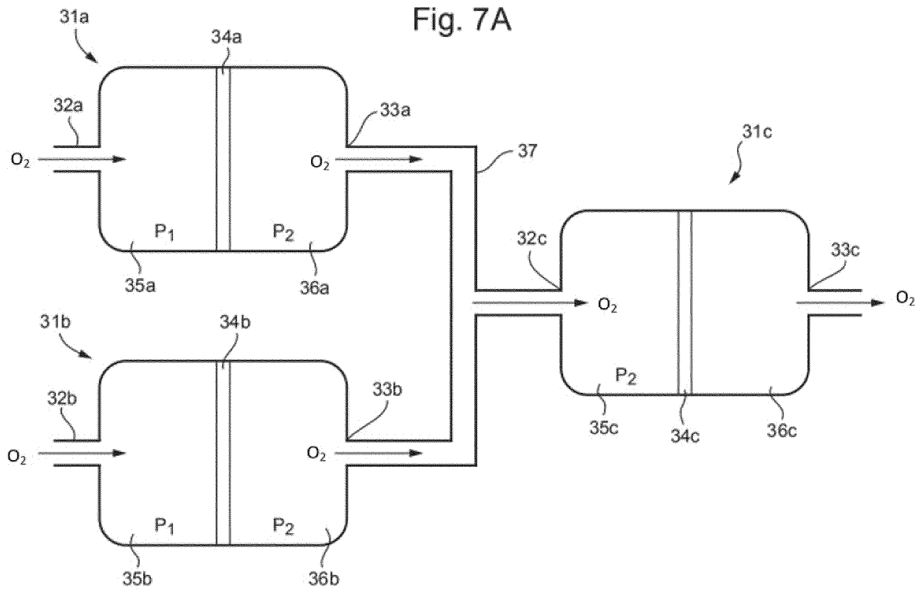

FIG. 6 shows the electrochemical cell of FIG. 5 with an additional cell for the further compression of oxygen,

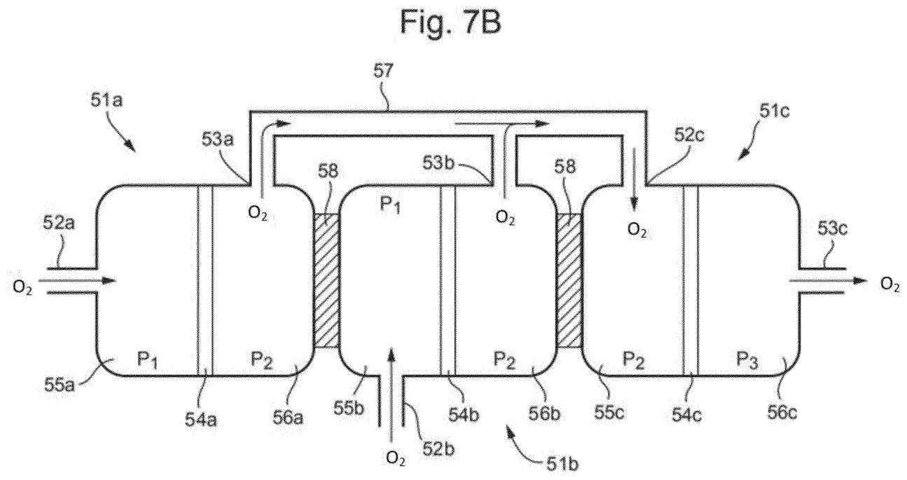

FIG. 7a depicts an electrochemical compressor comprising multiple cells as a first stage of compression, and

FIG. 7b depicts an electrochemical compressor comprising multiple cells as a first stage of compression in an alternative arrangement.

Referring to FIG. 1, there can be seen a single cell AEM electrochemical compressor 1. There is an inlet 2 and an outlet 3. Through the inlet 2 a stream of predominantly oxygen from either an electrolyser or other oxygen source is fed to an cathodic half-cell 5 the MEA 4 separates the cathodic half-cell 5 from the anodic half-cell 6. The oxygen enters the cathodic half-cell 5 at a first pressure, P₁, and is increased to a second higher pressure, P2, in the anodic half-cell 6. The reactions in both the cathode and anode half-cells follow:

AEM Cathode (ORR)

O₂+4e⁻+2H₂O [symbol] 4OH⁻

AEM Anode (OER)

4OH⁻ [symbol] O₂+4e⁻+2H₂O

The MEA 4 separates the two half-cells, and will comprise of at least cathode, anode and AEM therebetween. Additional layers such as a second AEM, GDL or MPL may be used, with their properties varying as required, as described above. FIG. 4 is an enlarged diagram of the MEA 4.

The water generated at the anode becomes bound to the membrane whereupon it is consumed in the cathodic reaction. The OH⁻ generated in the cathode migrates to the anode whereupon it is consumed in the anodic reaction. The electrons from the anode are consumed at the cathode.

It is noted that contaminants such as water or hydrogen may be present in the oxygen inlet. Neither is problematic as the water will behave as discussed above, and the hydrogen, depending on the catalyst used, could either react with the oxygen forming water or, being purified by the previously discussed methods. Other contaminants may include components of air in instances where the present invention is intended for use in obtaining oxygen from air.

It is most probable that a single cell AEM electrochemical compressor will be insufficient to reach the required pressure, as such a plurality of cells may be used in series forming a stack, as can be seen in FIG. 2.

FIG. 2 (BOP not shown) depicts a plurality of cells, 1ₐ 1b and 1c, forming a stack 10. the square brackets around 1b demonstrate that there may be more than three cells in a stack. The number of cells in a stack is not intended to be a limiting feature of the present invention. Oxygen from an electrolyser, or interim storage, or other source enters the first cathodic compartment at P₁ through the inlet 2a. The cathodic reaction occurs, with oxygen being generated at the anode in the anodic reaction until P₂ is reached in 3a. The oxygen at P₂ from the first anode 6a is communicated to the cathode of a second cell 5b, still at P₂ through the outlet 3a which is connected to the inlet 2b. The second cathodic and anodic reactions occur in half-cells 5b and 6b, with oxygen being produced in the second anodic 6b compartment until P₃ is reached. This continues in series until the final cell of the stack, in this FIG. 1c, wherein the oxygen is fed to a storage tank, or other destination requiring pressurised oxygen from the final outlet, 3c at the final pressure P₄. The control system and BOP are not shown.

Referring to FIGS. 3a and 3b, shown are cells with a varied MEA cross-sectional area. FIG. 3a shows a single cell 11 with a narrowing 7 for the MEA 4, FIG. 3b shows two such cells in series. The two dashed lines X-X show the MEA 4 of the second cell is smaller than that of the first. Such variances are intended to help manage the mechanical stresses imposed upon the MEA observed in each cell within the stack and improve water management. Other means disclosed include varying membrane in terms of thickness, mechanical as well as chemical and physio-chemical properties, and cell components as discussed hitherto (i.e. WAMM, type and placement of MPLs, composite membranes, etc. . . . ).

Referring to FIG. 4 a schematic of an MEA 4 with various constituent parts can be seen. From left to right the order is: cathodic GDL 45a, cathodic catalyst 42, anion exchange membrane 41, anodic catalyst 43, MPL 44 and anodic GDL 45c. The core components are the two catalysts, and membrane, the other components may improve functionality of the system. The MPL 44 can vary between cells to have different properties to achieve the desired outcome, such differences are not illustrated. A more hydrophobic MPL in latter cells of a stack should minimise water escaping the membrane, thereby ensuring the compressed oxygen leaving the stack is as dry as possible. Not shown is a variant where an MPL is present on the cathodic side as well as anodic side, or the MPL being on the cathodic side only.

Referring to FIG. 5, there can be seen a diagram of an electrochemical cell 21 in accordance with the present invention suitable for the compression of oxygen, whilst also separating oxygen from a stream of gas containing oxygen and contaminants, or as an oxygen sensor. Firstly, the operation as a means of stripping oxygen will be discussed.

The cathodic half-cell 25 of this embodiment has an inlet 22 for the introduction of a fluid stream comprising oxygen, and a cathodic outlet 27 for the transfer of the other contaminate gases to prevent a build-up of pressure in the cathodic half cell 25, the means for regulating outlet, normally a valve, on outlet 27 are not shown. When current is applied to the cell, the oxygen will react as disclosed in earlier embodiments, whilst the remaining gases do not. This means the oxygen crosses the AEM 24 to reach the anodic half-cell 26 with the contaminate gases remaining in the cathodic half cell 25. The oxygen leaves the anodic half-cell 26 at an elevated pressure P₂. The pressure of P₂ may be regulated by any known pressure regulating means, such as a valve, in this and any embodiment to allow for the pressure to build.

The cell as depicted in FIG. 5 may also be used as an oxygen sensor. In such an embodiment the gas stream, in which it is not known if oxygen is present, is fed to the cell 21 by the inlet 22. A small voltage is applied to the cell, and if there is oxygen present a current will be detectable. The measured current should be proportional to the partial pressure, or concentration of oxygen within the stream. Alternatively, an open circuit potential/voltage may be measured passively if there is a gradient in the oxygen partial pressure of each catalytic half-cell. The outlet 27 in the cathodic half-cell allows for the removal of the other gases to prevent the undesired build of pressure due to the other contaminant gases remaining in the cathodic half-cell. The anodic outlet 23 in the cell adapted for the detection of oxygen communicates oxygen from the cell either for further compression, or other purposes. The sensor may be used merely to detect the presence of oxygen, to inform a user of its presence, as such no compression in such an embodiment may be desired.

Referring to FIG. 6, the cell of FIG. 5, 21a can be seen with the anodic outlet 23a being connected to the cathodic inlet 22b of a second cell 21b in a stack, it should be noted more cells may be connected to allow for further compression of oxygen. The modus operandi largely mirrors the description of other stacks, the difference being the stripping of oxygen from a contaminated stream in cell 21a. The purified, and compressed oxygen in the anodic half-cell 26a is communicated to the cathodic half-cell 25b by the outlet/inlet 23a, 22b. The cell 21b will further compress the oxygen as it crosses the membrane 24b to the anodic half-cell 26b. It should be noted that further cells may be used in series should further compression be desired.

FIGS. 7a and 7b depict two embodiments of an alternative arrangement for an electrochemical stack. Firstly, referring to FIG. 7a, the at least two electrochemical cells 31a and 31b forming stack for the first stage of compression are connected in parallel. Oxygen enters each anode 35a, 35b at a first pressure, and when current is applied the cathodic and anodic reactions, disclosed above occur. Oxygen reforms in the anodic half-cells 36a and 36b, and pressure and flow regulating means (not shown) allow for the communication of oxygen from the anodic outlets 33a and 33b at a second pressure. The anodic outlets at each stage are then combined, see pipe 37, with the oxygen at a second pressure forming the feed for the cathodic inlet 32c of the cell or cells in the next compression stage. There is no limit to the number of cells in each stage, or the number of stages of compression. The pressure differential of each cell in a stage generally will be the same, but can differ between stages.

Lastly, referring to FIG. 7b there can be seen an electrochemical compressor with multiple cells, 51a and 51b forming a stage. There can be more than two cells in each stage, as discussed above. Oxygen enters through the cathodic inlets 52a 52b at a first pressure, crossing the membranes 54a and 54b via the reaction mechanism disclosed above, and reforming in the anodic half-cells 56a 56b. Oxygen at a second pressure is communicated from the anodic half-cells, via anodic outlets 53a and 53b to piping 57, the stream forming the feed for the next stage of compression. Oxygen enters the cell in the next stage of compression 51c through the cathodic inlet 52c. The cells 51a, 51b and 51c, are separated by insulating layers 58.

It should be noted that, although not shown, the feed 57 will comprise pressure regulating means and other features constituting BOP.

For clarity, in these examples cells 31a, 31b constitute a stage, and cell 31c constitutes a stage. Similarly in FIG. 7b cells 51a and 51b constitute a stage and cell 51c a stage of its own. In FIG. 2 cells 1a, 1b and 1c are each their own stage. Stages may have the same, or varying numbers of cells, dependent upon the requirements. Each stage may have 2 or more cells forming said stage.

In order to maintain a constant flowrate, the sum of current upon the membranes of the cells in each stage will be substantially similar when the pressure differential in each cell is the same. If the cells of one stage have a higher pressure differential, then the current density will be higher to account for back flow etc. as discussed above.

The invention is not intended to be restricted to the details of any of the above described embodiments. For instance, any electrochemical compressor for oxygen using a cell or cells with an AEM is likely to be covered by the present invention.

The method of manufacture of components within the electrochemical compressor is not intended to be a limitation upon the present invention.

Whilst the oxygen exiting the compressor should be mostly dry, a dryer may be provided on the final outlet to ensure the oxygen is substantially dry prior to pressurised storage, or use, if required.

The present invention is not intended to be limited by the catalyst used (although there is a preference for non-PGM), the membrane composition, the final pressure or any other such component.

Whilst it is envisaged a pH gradient with acidic and alkaline regions at opposing ends may occur at extreme current densities, it is preferred that the pH in the present invention is substantially 7, or higher, more preferably still substantially 9 to substantially 14 and even more preferably substantially 12 to substantially 13. In any case, the present invention is not reliant upon a pH gradient.

Whilst it is often necessary to compress oxygen, it is envisaged that the present invention may be used for the purification of a oxygen stream only, with no compression desired. In such an embodiment a cell, or stack thereof, in accordance with the present invention may be used without means for pressure regulation intended for compression, such as but not limited to valves, between the cells would allow for the flow of oxygen between cells and the purification occurring therein. The means for water management disclosed aid in the drying of oxygen. The cells as described and depicted may be configured in accordance with any of the disclosed features, i.e. as a sensor, compressor, dryer or combination thereof.

Contaminants would normally remain in the first cathodic half-cell. If contaminants other than water are present, an outlet for the cathodic half-cell is preferable to prevent a build-up of pressure in the first cell as well as optional means for removing contaminants such as CO₂ discussed above. The outlet allows for the purge of water as well, in order to prevent the cathode flooding.

Whilst it is envisaged that the compressed oxygen will be used for industrial processes, medical purposes, storage, or in a fuel cell, alternative uses are not excluded by this application.

Whilst there can be a large number of cells in a stack, it is not envisaged that oxygen substantially above 1000 bar will be required. If the pressure is raised by 35 bar per cell it is envisaged each stack will have no more than 30 cells.

The present invention can be arranged in a plurality of ways, with one or more cell forming a stage of compression, each stage may be considered a stack. Such stacks may be arranged in series or parallel themselves.

The present invention is not dependent upon an acidic environment or PGM catalysts, and has no moving parts. The system is therefore inherently more efficient than known alternatives, improving the green credentials of oxygen compression.

1. An electrochemical cell comprising:
a cathodic half-cell having an inlet configured to receive a gaseous stream comprising oxygen at a first pressure;
an anodic half-cell having an outlet configured to transfer oxygen at a second pressure;
a membrane electrode assembly (MEA) separating said cathodic half-cell and said anodic half-cell; and
a power source;
wherein said MEA comprises at least:
a cathodic electrode
an anodic electrode; and
at least one anion exchange membrane (AEM) therebetween.

2. An electrochemical cell according to claim 1, comprising at least one cathodic outlet.

3. An electrochemical cell according to claim 1 or claim 2, further comprising pressure regulating means at any one or more of:
the inlet of the cathodic half-cell;
the outlet of the anodic half-cell;
an outlet of the cathodic half-cell, if present.

4. An electrochemical cell according to 3, wherein a pressure regulating means at the outlet of the anodic half-cell is configured to, in use, maintain a gas pressure in the anodic half-cell greater than a gas pressure in the cathodic half-cell.

5. An electrochemical cell according to any of the preceding claims, wherein the MEA further comprises one or more catalysts.

6. An electrochemical cell according to claim 5, wherein the or each catalyst is not a platinum group metal.

7. An electrochemical cell according to any of the preceding claims, wherein the MEA further comprises any one or more of:
a cathodic gas diffusion layer (GDL);
an anodic GDL;
a microporous layer (MPL) at an anodic and/or a cathodic side;
a water management membrane at a cathodic and/or an anodic side; and
a membrane support at an anodic and/or a cathodic side.

8. An electrochemical cell according to any of the preceding claims, wherein said AEM comprises a composite membrane.

9. An electrochemical cell according to any of the preceding claims, wherein said AEM is doped with a source of OH⁻.

10. An electrochemical cell according to any of the preceding claims, including an ionomer on at least a cathodic side of the AEM; and/or
including an ionomer on a cathodic and anodic side of said AEM, the concentration of said ionomer being varied on one or both of the anodic and cathodic sides.

11. An electrochemical cell according to any of the preceding claims, wherein the MEA is ionomer-free and/or binder-free on at least one of an anodic or a cathodic side of said AEM.

12. An electrochemical cell according to any of the preceding claims, wherein the AEM comprises hygroscopic particles.

13. An electrochemical cell according to claim 12, wherein said hygroscopic particles are arranged in a concentration gradient, the concentration thereof being higher on a cathodic side of the AEM.

14. An electrochemical cell according to claim 12 or claim 13, wherein said hygroscopic particles are arranged in a concentration gradient, the concentration gradient being non-linear.

15. An electrochemical cell according to any of the preceding claims, when dependent on claim 3, wherein a pressure regulating means is configured to, in use, maintain a pressure differential across the cell in the range 1-1000 bar.

16. An electrochemical cell according to any of the preceding claims, comprising a moisture sensor coupled to the outlet of said anodic half-cell.

17. An electrochemical cell according to any of the preceding claims, wherein, in use, during ramp down, power generated by the cell is stored.

18. An electrochemical cell according to any of the preceding claims, wherein said power source is reverse pulse.

19. An oxygen sensor comprising an electrochemical cell according to any of the preceding claims, wherein the first cathodic half-cell comprises an outlet, the sensor further comprising means for applying a voltage to said cell and a current measuring means configured to measure a current through the cell as a result of said voltage being applied, a current being indicative of the presence of oxygen in a gas stream flowing therethrough.

20. An oxygen sensor comprising an electrochemical cell according to any of claims 1 to 19, wherein said cathodic half-cell comprises an outlet, the sensor further comprising means for causing a current to flow through said cell and a voltage measuring means configured to measure a voltage across the cell as a result of said current being applied, a voltage being indicative of the presence of oxygen in a gas stream flowing therethrough.

21. Apparatus for stripping oxygen from a gaseous stream, the apparatus comprising an electrochemical cell according to any of claims 1 to 19, wherein said cathodic half-cell is provided with an outlet configured to allow contaminate gases therein to be vented.

22. An electrochemical cell assembly comprising at least first and second electrochemical cells according to any of claims 1 to 19, configured in a stack, wherein the outlet of the anodic half-cell of said first electrochemical cell is in fluid communication with the inlet of the cathodic half-cell of the second electrochemical cell.

23. An electrochemical cell assembly according to claim 22, comprising a plurality of electrochemical cells according to any of claims 1 to 19 arranged in series as a stack, wherein the outlet of the anodic half-cell of each electrochemical cell except the last electrochemical cell in the stack is in fluid communication with the inlet of the cathodic half-cell of the immediately adjacent electrochemical cell in the in the stack, and the outlet of the anodic half-cell of the last electrochemical cell in the stack is configured to deliver oxygen to an external destination.

24. A method of processing a gaseous stream containing oxygen, comprising providing an electrochemical cell according to any of claims 1 to 19, feeding a oxygen-containing gaseous stream to the inlet of the cathodic half-cell, and transmitting oxygen from the outlet of the anodic half-cell.

25. A method of processing a gaseous stream containing oxygen, comprising providing an electrochemical cell assembly according to claim 22 or claim 23, feeding a oxygen-containing gaseous stream to the inlet of the cathodic half-cell of the first electrochemical cell in the stack, transferring oxygen from the outlet of the anodic half-cell of each electrochemical cell in the stack to the inlet of the cathodic half-cell of another electrochemical cell, and delivering oxygen from the output of the anodic half-cell of a last electrochemical cell in the stack to an external destination.
